(19) United States
(12) Patent Application Publication
(10) Pub. No.: US 2019/0130670 A1
(43) Pub. Date: May 2, 2019

(54) ELECTRONIC MANUAL DISPLAY METHOD AND ELECTRONIC MANUAL CONTROL DEVICE

(71) Applicant: HONDA MOTOR CO., LTD., Minato-ku, Tokyo (JP)

(72) Inventors: Masataka Takao, Minato-ku, Tokyo (JP); Ouki Itou, Minato-ku, Tokyo (JP); Naoki Kawahara, Minato-ku, Tokyo (JP)

(21) Appl. No.: 16/096,312

(22) PCT Filed: Apr. 7, 2017
(86) PCT No.: PCT/JP2017/014512

§ 371 Date: Oct. 25, 2018

(30) Foreign Application Priority Data
Apr. 27, 2016 (JP) 2016-089074

(51) Int. Cl. G07C 5/08; G07C 5/00

(52) U.S. Cl. CPC G07C 5/0825; G07C 5/008

(57) ABSTRACT

The objective of the present invention is to provide an electronic manual display method and an electronic manual control device with which it is possible, for example, to improve the work efficiency of failure diagnosis. An electronic manual control device displays an inspection work selecting screen which displays collectively, for each diagnostic trouble code (DTC): a failure summary display region displaying a summary of a failure corresponding to the DTC; a detection range display region displaying graphically the detection range of the DTC; and an inspection location display region which selectably displays, as options, inspection work items within the detection range associated with the DTC, categorized into minimum work items. When one option is selected, an inspection work explanation screen corresponding to said option is displayed by a display device.

### TECHNICAL FIELD

The present invention relates to an electronic manual display method and electronic manual control device for displaying an electronic manual for performing fault diagnosis based on a trouble code stored in an electronic control unit within a vehicle.

### BACKGROUND ART

When an anomaly occurs in an electronic control unit (ECU) of a vehicle, the driver recognizes anomaly symptoms, illumination of a warning lamp, or the like, and brings the vehicle to a dealer or a maintenance shop, where fault diagnosis relating to the anomaly symptoms or illumination of the warning lamp is carried out. A repair person (a technician) can grasp the details of the fault by reading a trouble code (DTC) stored in the ECU of the failed vehicle corresponding to the time of occurrence of the fault via a fault diagnostic instrument.

Then, during the fault diagnosis, by sequentially displaying a diagnostic work procedure corresponding to the trouble code on a monitor screen of the fault diagnostic instrument with previous consultation of a service manual and the like, even an inexperienced technician can find the location of the fault relatively easily (U.S. Pat. No. 5,491,631 and U.S. Patent Application Publication No. 2001/0002450).

However, a problem of such a technique is that it is difficult to grasp the position of the “currently designated work” within the series of diagnostic works, the purpose or meaning of the work, or the like, because work instructions are sequentially displayed on the screen. Also, the diagnosis tends to be makeshift because one can handle a fault by sequentially conducting works according to instructions on the screen. Thus, such a technique cannot be said to be a tool suitable for an inexperienced technician to acquire a learning effect of work experience.

To address this, U.S. Patent Application Publication No. 2013/0218401 (hereinafter referred to as “US 2013/0218401 A1”) provides juxtaposed display of an overall work display area 114 including a flowchart 120 of all the diagnostic items involved for a fault, and a specific work display area 116 individually showing specific works, where display of the currently displayed work content and display of the diagnostic item to which the work content belongs within the entire process are sequentially switched at the same time per work content (Abstract, FIGS. 3 to 7). This allows a user to perform diagnostic work while checking the position of the currently displayed work by comparison ([0011]). The overall work display area 114 and the specific work display area 116 are selected in accordance with a trouble code (DTC) read from an ECU 20 (Abstract).

### SUMMARY OF INVENTION

As mentioned above, the overall work display area 114 of US 2013/0218401 A1 shows all the diagnostic work items corresponding to a DTC and the specific work display area 116 shows the specific work contents of the individual work items included in the entire diagnostic work. US 2013/0218401 A1 thus allows a user to grasp the work items as a whole using the overall work display area 114. However, it has a problem in that the user is unable to grasp the overview of the overall work content unless the user sequentially checks the contents of all the individual works along the diagnosis procedure. Another problem of US 2013/0218401 A1 is that since a procedure is predetermined, a skilled operator is not allowed to narrow down the location of a malfunction by setting priorities to individual works (for example, selective execution of an inspection work with higher priority given to a location which he/she can intuitively guess to be the location of a malfunction) by making use of his/her experience and know-how.

In view of these circumstances, an object of the present invention is to provide an electronic manual display method and electronic manual control device that allow a user to roughly grasp work processes required for fault diagnosis, the number of processes, and their difficulty levels and that can significantly improve the efficiency of the actual works.

An electronic manual display method according to the present invention is an electronic manual display method for displaying an electronic manual for performing fault diagnosis based on a trouble code stored in an electronic control unit within a vehicle, in which an electronic manual control device configured to control display of the electronic manual includes: an inspection work selection screen which displays together, a fault overview display area which displays an overview of a fault corresponding to the trouble code, a detection range display area which graphically displays a detection range in which the trouble code is detected, and an inspection part display area which displays inspection work items in the detection range associated with the trouble code by categorizing the inspection work items into smallest work items which are selectable as options; and an inspection work description screen which displays a detailed description of inspection work content corresponding to each of the work items, and, when one of the options is selected on the inspection work selection screen, the inspection work description screen corresponding to the option is displayed on a display device.

According to the present invention, the inspection work selection screen displays an overview of the fault corresponding to a trouble code, a diagram of the detection range in which the trouble code is detected, and multiple options which show the inspection work items corresponding to the trouble code and present in the detection range by categorizing them into the smallest work items. Thus, information items for allowing the user to promptly understand the overview of the inspection works corresponding to the trouble code can be displayed all together on a single screen. As there are as many trouble codes as more than several hundreds, even a professional cannot make a determination only with a trouble code and/or its name. The present invention enables a user (a technician as a repair person) to quickly recognize, just by glancing at a screen, a target component and/or an overview of a work for it, which are commonly difficult to recognize only with a trouble code. Accordingly, the user can roughly grasp the work processes required for fault diagnosis corresponding to a trouble code, the number of processes, and their difficulty levels, and promptly present a repair time or a quote to a customer.

Also, options for multiple inspection works which are associated with a trouble code and categorized in terms of components in the diagram of the detection range are displayed in units of the smallest inspection works in a user-selectable manner. The user can thus recognize the inspection works for a fault-causing part in units of the smallest inspection works beforehand. Accordingly, the user can decide an inspection work procedure on his/her own by making use of his/her skills or expertise without having to adhere to a common and standard inspection work order, so that he/she can perform flexible diagnostic work in view of customer information and the like. This can significantly improve the work efficiency of fault diagnosis.

The detection range display area may be a circuit diagram showing electrical connection relation between target components in the detection range, and the inspection part display area may display the work items as classified for each of the target components. This enables the user to select inspection works in units of the smallest inspection works at the target component level corresponding to a trouble code on the inspection work selection screen and estimate the location of fault occurrence in the circuit more easily. For a user with high skills in particular, narrowing down of the location of fault occurrence would be facilitated.

The inspection work description screen may include: a work content display area which displays a work key point for a measurement work relating to the selected work item and a decision criterion for measured data together; and a repair work display area which displays content of a repair work when the decision criterion is not satisfied.

In this manner, work key points for a measurement work relating to a selected work item and a decision criterion for the measured data are displayed together such as in a juxtaposed manner. Thus, the user can both grasp the work content of the selected work item at a glance and readily recognize the content of a repair work that is to be done when the decision criterion is not satisfied.

An electronic manual control device according to the present invention is configured to control display of an electronic manual for performing fault diagnosis based on a trouble code stored in an electronic control unit within a vehicle. The electronic manual control device includes: an inspection work selection screen which displays together, a fault overview display area which displays an overview of a fault corresponding to the trouble code, a detection range display area which graphically displays a detection range in which the trouble code is detected, and an inspection part display area which displays inspection work items in the detection range associated with the trouble code by categorizing the inspection work items into smallest work items which are selectable as options; and an inspection work description screen which displays a detailed description of inspection work content corresponding to each of the work items. When one of the options is selected on the inspection work selection screen, the inspection work description screen corresponding to the option is displayed on a display device.

The present invention facilitates identification of a point for inspection during a diagnostic work conducted based on a trouble code and can improve the work efficiency of fault diagnosis. In addition, since a detection range is displayed per trouble code and the smallest work items can be grasped, the user can gain an effect of improving his/her skills through experience in making decisions for selecting works.

### BRIEF DESCRIPTION OF DRAWINGS

FIG. 1 schematically shows a configuration of an electronic manual display system including a computation unit as an electronic manual control device according to an embodiment of the present invention;

FIG. 2 shows a first example of an overview description screen according to the embodiment;

FIG. 3 shows a first example of an inspection work description screen according to the embodiment;

FIG. 4 shows a second example of the inspection work description screen according to the embodiment;

FIG. 5 shows a second example of the overview description screen according to the embodiment;

FIG. 6 shows a third example of the inspection work description screen according to the embodiment;

FIG. 7 shows a fourth example of the inspection work description screen according to the embodiment;

FIG. 8 is a flowchart illustrating an overall flow of the actual utilization of an electronic manual in the embodiment; and

FIG. 9 is a diagram illustrating screen transitions in the electronic manual according to the embodiment.

### DESCRIPTION OF EMBODIMENTS

### A. Embodiment

### A-1. Configuration

### A-1-1. Overall Configuration

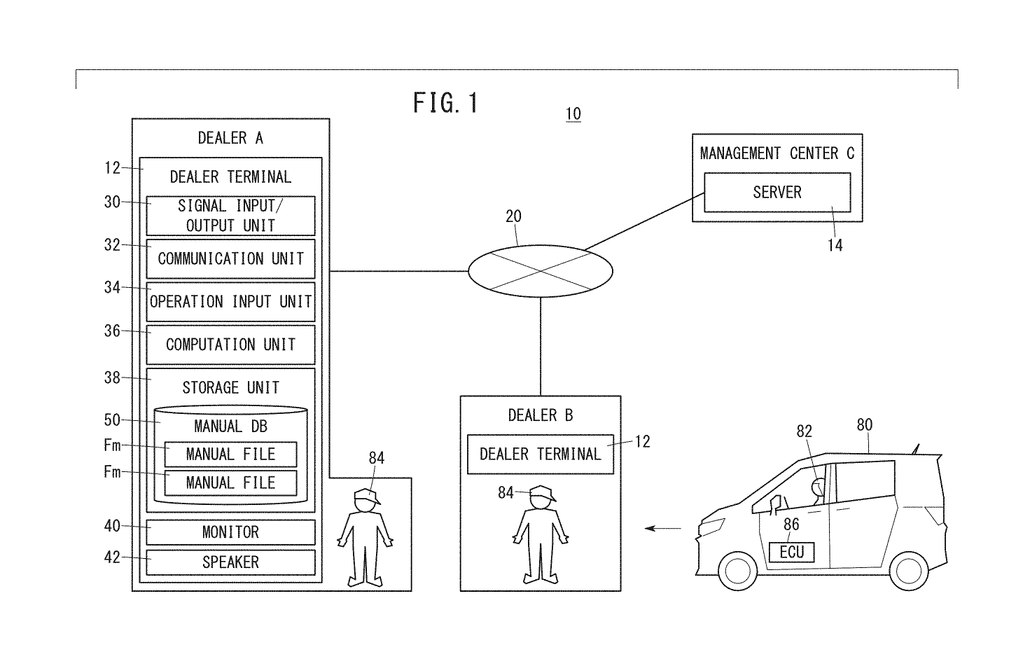

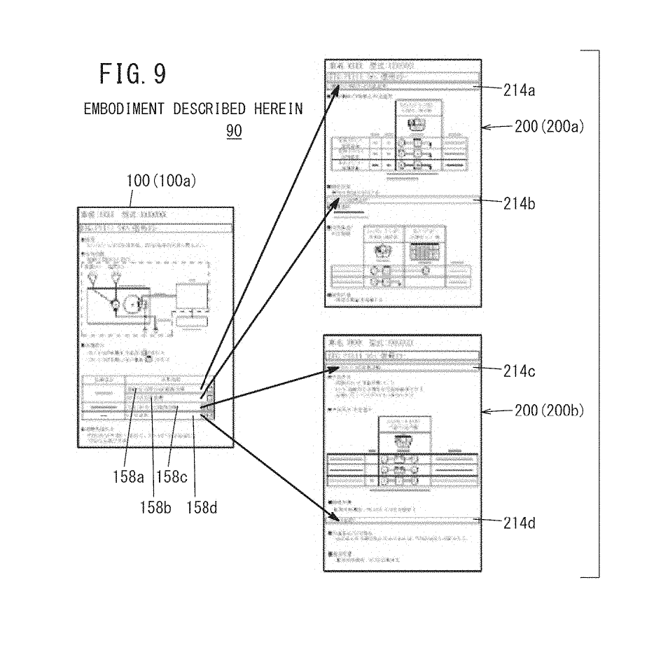

FIG. 1 schematically shows a configuration of an electronic manual display system 10 (also referred to as “system 10” or “display system 10” hereinbelow) including a computation unit 36 as an electronic manual control device according to an embodiment of the present invention. The system 10 is a system for displaying an electronic manual 90 (FIG. 9) during maintenance and diagnosis of a vehicle 80.

The system 10 includes multiple dealer terminals 12 (also referred to as “terminals 12” hereinbelow) and a server 14. The terminals 12 are located at multiple car dealers A, B (also referred to as “dealers A, B” hereinbelow) being service locations. The server 14 is located at a management center C. In this embodiment, the terminals 12 and the server 14 can communicate with each other over a communication network 20.

### A-1-2. Dealer Terminal 12

To the dealer A, B, a customer 82 brings his/her own vehicle 80 for the purpose of maintenance or diagnosis. The dealer terminal 12 is used when an operator 84 (technician) or the like at the dealer A, B consults the electronic manual 90 for performing maintenance or diagnosis on the vehicle 80 (a completed product).

As shown in FIG. 1, the terminal 12 includes a signal input/output unit 30, a communication unit 32, an operation input unit 34, the computation unit 36, a storage unit 38, a monitor 40, and a speaker 42. The signal input/output unit 30 inputs and outputs signals between the terminal 12 and an external device. The communication unit 32 communicates with the server 14 over the communication network 20. The communication unit 32 may be regarded as a part of the signal input/output unit 30. The operation input unit 34 (an operation input device) is a device through which a user such as the operator 84 performs input and output, and has a keyboard and a mouse, for example.

The computation unit 36 controls components of the terminal 12 to execute various kinds of processing. The computation unit 36 in this embodiment reads data Dm (also referred to as “manual data Dm” hereinbelow) for the electronic manual 90 (FIG. 9) from the storage unit 38 according to an input from the operation input unit 34 and displays it on the monitor 40. The computation unit 36 also retrieves the latest manual data Dm from the server 14 via the communication unit 32 and the network 20. In this embodiment, the manual data Dm is used in the form of a manual file Fm.

The storage unit 38 (a storage device) stores various programs and data such as control programs used by the computation unit 36. Data as called herein includes multiple manual data Dm (manual files Fm) corresponding to multiple vehicle types. The storage unit 38 includes a manual database 50 (hereinafter referred to as “manual DB 50”) storing multiple manual data Dm (manual files Fm) therein.

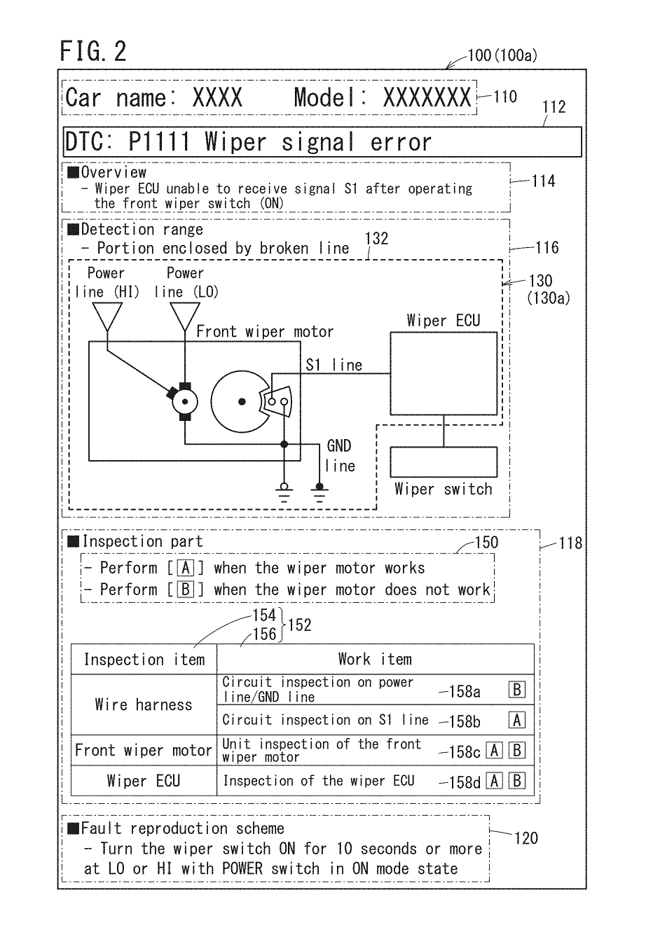

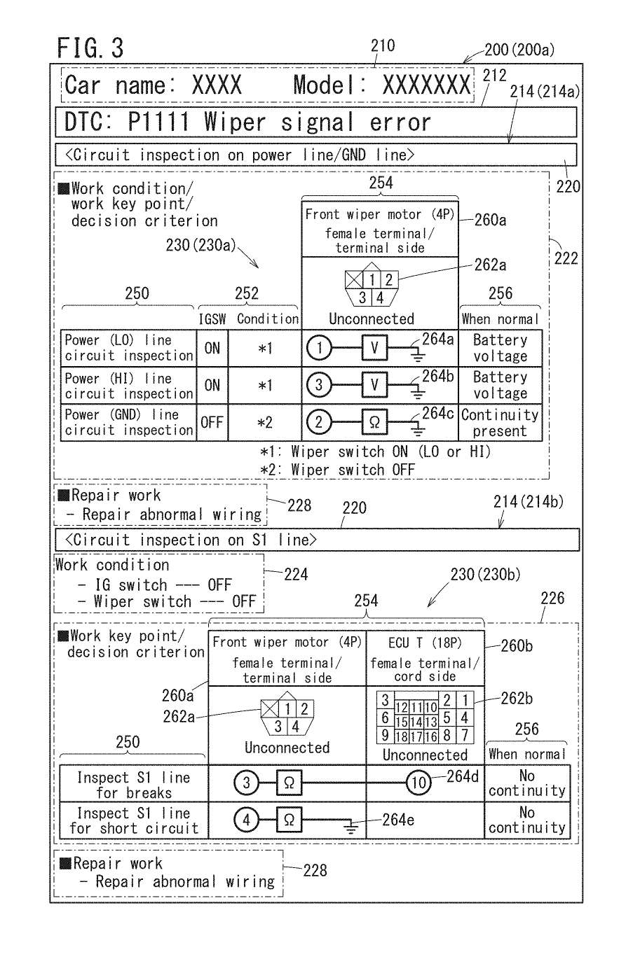

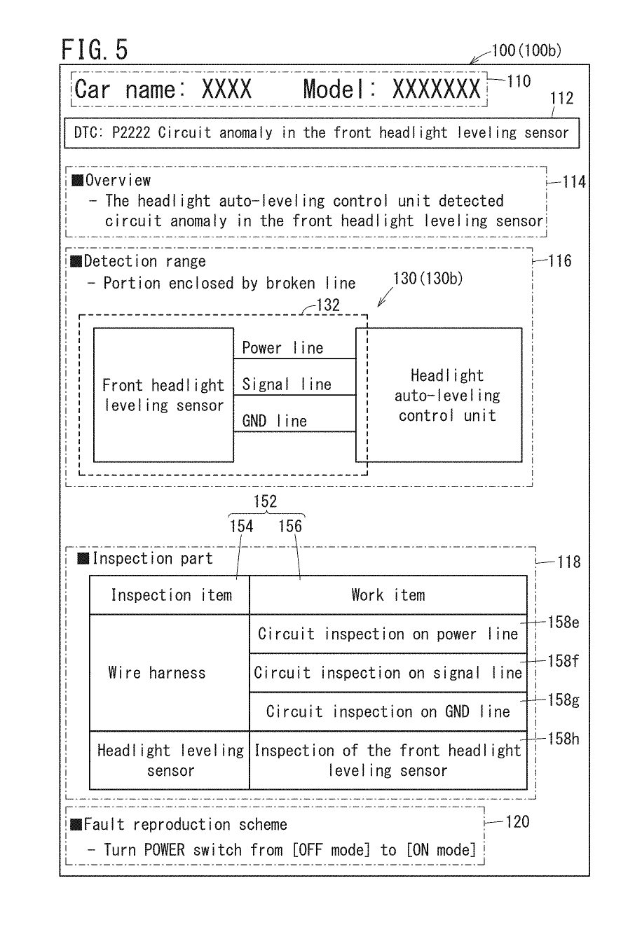

Each manual data Dm includes overview description screen data D1 and inspection work description screen data D2. The overview description screen data D1 is data relating to an inspection work selection screen 100 (FIGS. 2 and 5). The inspection work description screen data D2 is data relating to an inspection work description screen 200 (FIGS. 3, 4, 6, and 7).

The overview description screen data D1 includes vehicle information Iv, DTC information Idtc, detection range information Ida, inspection part information Itp, and fault reproduction scheme information Ir. The inspection work description screen data D2 includes vehicle information Iv, DTC information Idtc, work condition information Ic, work key point information Ip, decision criterion information Is, and repair work information Irp. These pieces of information will be discussed in detail later.

The monitor 40 (a display device) displays the electronic manual 90 (FIG. 9) and the like based on commands from the computation unit 36. The speaker 42 outputs sound associated with display of the electronic manual 90 based on commands from the computation unit 36.

In terms of hardware configuration, the terminal 12 may be a desktop or notebook personal computer, for example. Alternatively, it may be a commercially available tablet computer or smartphone. Although FIG. 1 shows the internal configuration of only the terminal 12 at dealer A, the terminal 12 at dealer B, and further terminals provided at other dealers as necessary (not shown) each have a similar configuration.

When the terminal 12 is used as a fault diagnostic instrument for the vehicle 80, the communication unit 32 of the terminal 12 may have features (such as a data link connector and a communication cable) capable of communication with an electronic control unit 86 (hereinafter referred to as “ECU 86”) of the vehicle 80. Although FIG. 1 shows only one ECU 86, the vehicle 80 has multiple ECUs 86 on which fault diagnosis may be performed.

### A-1-3. Server 14

The server 14 is responsible for management of the entire system 10 and provides the latest manual file Fm to the terminals 12 at the dealers A, B. Like the terminal 12, the server 14 includes a signal input/output unit, a communication unit, an operation input unit, a computation unit, a storage unit, a monitor, and a speaker (none of which is shown). The storage unit of the server 14 has a manual database storing the latest manual file Fm therein.

### A-2. Configuration and Content of Electronic Manual

The configuration and content of the screens included in the electronic manual file Fm are described first, followed by description of the overall flow of a work procedure utilizing an electronic manual.

### A-2-1. Description of Screens

In this embodiment, as the screens forming an electronic manual, the inspection work selection screen 100 (FIGS. 2 and 5) and the inspection work description screen 200 (FIGS. 3, 4, 6, and 7), which is displayed as a result of making selection in the selection screen 100, are separately displayed (FIG. 9).

### A-2-1-1. First Fault Instance

As a first fault instance, a case where DTC “P1111” (wiper signal error) is detected will be described below.

### A-2-1-1-1. Inspection Work Selection Screen 100

### A-2-1-1-1-1. Outline of Inspection Work Selection Screen 100

FIG. 2 shows a first example of the inspection work selection screen 100 in this embodiment. The inspection work selection screen 100 of FIG. 2 is a screen for selecting an inspection work when an error occurs in an input signal to a wiper not illustrated (hereinafter referred to as “wiper signal”). Hereinafter, the inspection work selection screen 100 of FIG. 2 will be also specifically referred to as inspection work selection screen 100a or selection screen 100a.

The selection screen 100 of FIG. 2 shows the entire screen on which pieces of information required for selecting inspection works are displayed all together, and the monitor 40 also shows its entirety. However, the screen may also be configured such that only a portion thereof is displayed on the monitor 40 and the entire screen may be accessed by scrolling. A “screen” in such a case includes an area being displayed on the monitor 40 and an area not being displayed on the monitor 40 (an area that can be accessed by scrolling).

As shown in FIG. 2, the inspection work selection screen 100 includes a vehicle information display area 110, a DTC display area 112, a fault overview display area 114 which displays an overview of the fault corresponding to the DTC displayed in the DTC display area 112, a DTC detection range display area 116 which graphically displays a detection range in which the DTC is detected, an inspection part display area 118 which displays inspection work items in the detection range by categorizing them into smallest work items which are selectable as options, and a fault reproduction scheme display area 120.

### A-2-1-1-1-2. Vehicle Information Display Area 110

The vehicle information display area 110 is an area which displays vehicle information Iv as information relating to the vehicle 80 on which diagnosis is performed. The vehicle information Iv includes the name (car name) and model of the vehicle 80. In FIGS. 2 and 5, the car name is simply displayed as “XXXX” and the model is simply displayed as “XXXXXXX”. Alternatively, the vehicle information Iv may include other pieces of information such as model year (for example, 2016 model) and destination (for example, Japan).

### A-2-1-1-1-3. DTC Display Area 112

The DTC display area 112 (also referred to as “DTC area 112” hereinbelow) is an area which displays a DTC itself and the name of the DTC (DTC name). The DTC and the DTC name are included in DTC information Idtc as information relating to the DTC. In FIG. 2, “P1111” is the DTC and the “Wiper signal error” is the DTC name.

### A-2-1-1-1-4. Fault Overview Display Area 114

The fault overview display area 114 is an area which displays an overview of the fault corresponding to the DTC. An overview of a fault is included in the DTC information Idtc. In FIG. 2, “Wiper ECU unable to receive signal S1 after operating the front wiper switch (ON)” is the overview of the fault.

### A-2-1-1-1-5. Detection Range Display Area 116

The detection range display area 116 (a connection relation diagram display area) is an area which graphically displays detection range information Ida as information relating to the detection range in which the DTC is detected. The detection range as referred to herein is a range including relevant components in which the anomaly (or fault) indicated by an individual DTC can occur.

As mentioned above, typically more than one hundred DTCs are defined, which makes it possible to identify, based on a DTC, the relevant components and the like associated with occurrence of the fault. The range of electric wiring over which such relevant components and the like should be inspected is defined as the detection range. An occurrence of a fault is attributed to either an anomaly of an individual component or an anomaly of harness connection. The detection range information Ida includes a circuit diagram 130 (connection relation diagram) showing the electrical connection relation among multiple parts in which the fault corresponding to the DTC can occur.

The circuit diagram 130 (also referred to as “circuit diagram 130a” hereinbelow) in the detection range display area 116 of FIG. 2 shows wiper circuit components (such as a front wiper motor and a wiper ECU) as the range in which the anomaly indicated by the DTC “P1111” can occur, with a broken line 132 in the circuit diagram 130a indicating the detection range. The wiper switch, not enclosed by the broken line 132, is not a component corresponding to the DTC “P1111” but is displayed as a reference component for easy grasping of the detection range.

### A-2-1-1-1-6. Inspection Part Display Area 118

The inspection part display area 118 (an inspection work display area) is an area which displays inspection part information Itp as information relating to inspection parts in the detection range indicated by the broken line 132 in the circuit diagram 130 within the detection range display area 116. The inspection part display area 118 of FIG. 2 includes a work item list 152 (also referred to as “list 152” hereinbelow), which categorizes the inspection work items in the detection range into smallest work items and displays them as independent options in a selectable manner, and a list description area 150 which displays supplementary description for selecting from these work items.

The work item list 152 is composed of juxtaposed display of an inspection item area 154 and a work item area 156 associated with it. The inspection item area 154 is an area which displays target components for inspection; in FIG. 2, the wire harness, the front wiper motor, and the wiper ECU represent specific inspection items.

The work item area 156 is an area which displays work items (or inspection works) which represent the inspection works relating to the respective inspection items by categorizing them into complete smallest works. In FIG. 2, “Circuit inspection on power line/GND line” and “Circuit inspection on S1 line” for the “wire harness”, “Unit inspection of the front wiper motor” for the “front wiper motor”, and “Inspection of the wiper ECU” for the “wiper ECU” represent the specific work items.

The list description area 150 is an area which displays supplementary description, if any, required for selecting from the work items displayed in the list 152. In FIG. 2, for selecting work items corresponding to respective inspection items, the descriptions “Perform ‘A’ when the wiper motor works” and “Perform ‘B’ when the wiper motor does not work” are displayed as descriptions relating to the list 152. Correspondingly, the work items in the work item area 156 each include work categories “A” and “B”, which are described in the list description area 150.

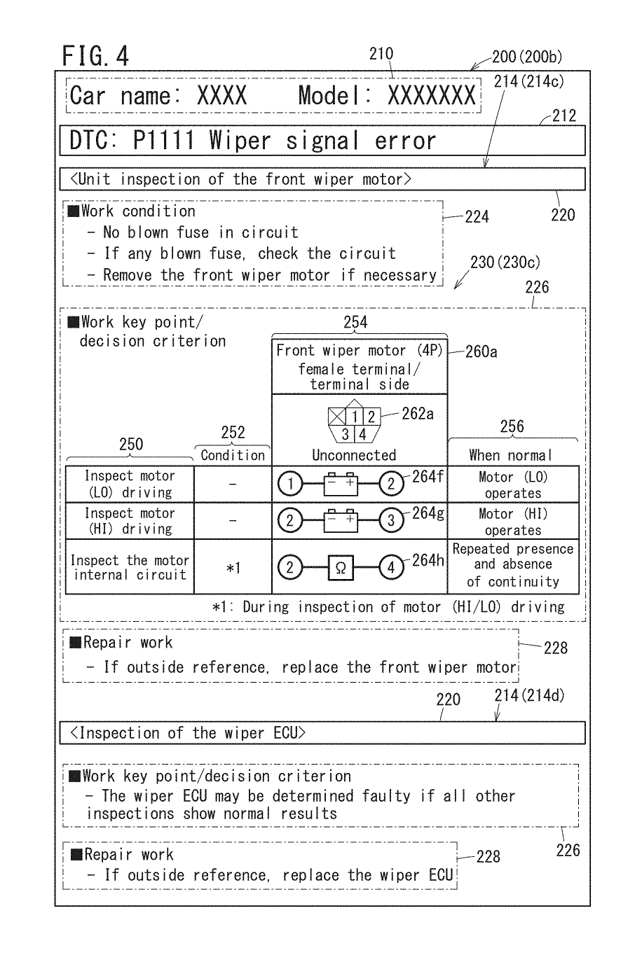

The work items included in the work item area 156 are configured as separate operation buttons (operation functions) representing the inspection work options 158a to 158d and being operable for selection. The options 158a to 158d function as display of links to detailed descriptions of the corresponding inspection work contents provided on the inspection work description screen 200 of FIGS. 3 and 4, which is described later.

### A-2-1-1-1-7. Fault Reproduction Scheme Display Area 120

The fault reproduction scheme display area 120 is an area which displays fault reproduction scheme information Ir as information relating to a scheme for reproducing the fault corresponding to the DTC (hereinafter referred to as “fault reproduction scheme”). In FIG. 2, the description “Turn the wiper switch ON for 10 seconds or more at LO or HI with POWER switch in ON mode state” is displayed as the fault reproduction scheme.

### A-2-1-1-2. Inspection Work Description Screen 200

### A-2-1-1-2-1. Outline of inspection work description screen 200

FIGS. 3 and 4 illustrate first and second examples of the inspection work description screen 200 for the first fault instance. The description screen 200 of FIGS. 3 and 4 will also be referred to as inspection work description screen 200a, 200b, respectively.

The description screens 200a, 200b of FIGS. 3 and 4 are combined with the inspection work selection screen 100a of FIG. 2. That is, the description screen 200a of FIG. 3 is a screen that appears first upon selection of the option 158a or 158b on the inspection work selection screen 100a of FIG. 2. The description screen 200b of FIG. 4 is a screen that appears first upon selection of the option 158c or 158d on the inspection work selection screen 100a of FIG. 2.

In FIGS. 3 and 4, the entire portion of the description screen 200a, 200b is shown as a single screen, and the screen is also displayed in its entirety on the monitor 40. However, the screen may also be configured such that only a portion thereof is displayed on the monitor 40 and the entire screen may be accessed by scrolling.

As shown in FIGS. 3 and 4, the inspection work description screen 200 has a vehicle information display area 210, a DTC display area 212, and an inspection work display area 214 which indicates that the work content corresponding to the option (work item) 158a, 158b, 158c, or 158d of the inspection work selection screen 100a in FIG. 2 is being displayed. For distinction of the display area 214 in correspondence to the options 158a to 158d, four display areas 214 will also be referred to as inspection work display areas 214a to 214d or display areas 214a to 214d, respectively, hereinbelow.

The contents displayed in the display areas 210, 212 of the inspection work description screen 200 are the same as those in the display areas 110, 112 of the inspection work selection screen 100, indicating that it is an explanatory material for the same DTC on the same vehicle. The inspection work display areas 214a to 214d are areas which display the contents of inspection works (target inspection works) corresponding to the options 158a to 158d of the inspection work selection screen 100.

### A-2-1-1-2-2. Inspection Work Display Area 214

### A-2-1-1-2-2-1. Outline of Inspection Work Display Area 214

The inspection work display area 214 is an area which displays information relating to the diagnostic work, such as a work condition or a work key point associated with the inspection work. As shown in FIG. 3, the display area 214a has a work item display area 220 which displays a work item selected from the options, a work content display area 222 which displays together the work conditions/work key point/decision criterion required for a measurement work relating to that work item, and a repair work display area 228.

In the inspection work display areas 214b, 214c, the work content display area 222 of FIG. 3 is displayed by being divided into a work condition display area 224 which displays only the work conditions and a work key point/decision criterion display area 226.

A measurement work content display area 230 (also referred to as “display area 230” hereinbelow) displays (or graphically shows) a measurement work condition relating to a selected work item, a work key point (the type of measurement sensor and point of measurement), and a decision criterion for measured data together in a juxtaposed manner. Hereinafter, the measurement work content display area 230 of the inspection work display areas 214a to 214c will be referred to as measurement work content display areas 230a to 230c or display areas 230a to 230c, respectively.

For example, the display area 230a of FIG. 3 displays the detailed description of the inspection work content linked to the smallest work item option 158a “Circuit inspection on power line/GND line” displayed in the work item area 156 of FIG. 2. The inspection work content consists of three checking works. Specifically, depending on the condition of combination between the ON/OFF of the ignition switch (IGSW) and the ON/OFF of the wiper switch, either voltage or continuity between a specified pin among the terminal pins of a four-pin coupler of the front wiper motor and a ground terminal is measured. The measurement is then checked against the displayed contents of the decision criterion display area 256 indicating a normal state, and whether there is an anomaly or not is determined.

For the display area 230a of FIG. 3, whether a battery voltage is being applied at the first pin and the ground (GND), whether the battery voltage is being applied at the third pin and GND, and whether there is continuity between the second pin and GND are the decision conditions serving as criteria for determining a normal state.

FIG. 3 shows two inspection work display areas 214a, 214b corresponding to two options 158a, 158b. However, from the viewpoint of displaying the inspection work display area(s) 214 corresponding to the options 158, for example, the number is not limited to two but there may be only one or three or more inspection work display areas 214, for example.

### A-2-1-1-2-2-2. Work Item Display Area 220

The contents displayed in the work item display area 220 correspond to the options 158a to 158d of the inspection work selection screen 100a as mentioned above. For example, in the inspection work display area 214a of FIG. 3, “Circuit inspection on power line/GND line” is displayed in correspondence to the option 158a of FIG. 2, while in the inspection work display area 214b, “Circuit inspection on S1 line” is displayed in correspondence to the option 158b of FIG. 2.

### A-2-1-1-2-2-3. Work Content Display Area 222

The work content display area 222 includes a checking work name display area 250, a work condition display area 252, a work key point display area 254, and a decision criterion display area 256. These areas will also be referred to as display areas 250, 252, 254, 256 hereinbelow.

The checking work name display area 250 is an area which displays the name of a checking work (a checking work name). In FIG. 3, “Power (LO) line circuit inspection”, “Power (HI) line circuit inspection”, and “Power (GND) line circuit inspection” respectively represent checking work names, and these three works constitute the smallest work item “Circuit inspection on power line/GND line” displayed in the work item display area 220.

The work condition display area 252 is an area which displays work condition information Ic as information on a condition for performing a checking work (hereinafter referred to as “work condition”). For example, in FIG. 3, the ON/OFF status of the ignition switch (IGSW) and the ON/OFF status of the wiper switch are shown as work conditions. More specifically, when a circuit inspection on the power (LO) line or power (HI) line is to be performed, “IGSW being ON” and “Wiper switch ON (LO or HI)” are the work conditions. When a circuit inspection on the power (GND) line is to be performed, “IGSW being OFF” and “Wiper switch OFF” are the work conditions.

The work key point display area 254 (also referred to as “display area 254” hereinbelow) is an area which displays work key point information Ip as information on the key point of an inspection work (hereinafter referred to as “work key point”). For example, in FIG. 3, the upper display area 254 includes a pin name 260a, a pin layout 262a, and measurement diagrams 264a to 264c as the work key point information Ip.

The pin name 260a indicates the name of a pin on which an inspection work is performed. In FIG. 3, “Front wiper motor (4P) female terminal/terminal side” is the pin name 260a, for example. The pin layout 262a is a diagram showing the position of the pin identified by the pin name 260a.

The measurement diagrams 264a to 264c show the type of measurement sensor and the point of measurement. For example, the measurement diagram 264a of FIG. 3 indicates measuring between the first pin and the ground (GND) with a voltmeter. The measurement diagram 264b indicates measuring between the third pin and the ground with a voltmeter. The measurement diagram 264c indicates measuring between the second pin and the ground with an ohmmeter.

The decision criterion display area 256 is an area which displays decision criterion information Is as information on a criterion for decision via an inspection work. In the inspection work display area 214a of FIG. 3, “Battery voltage” and “Continuity present”, indicative of a normal state, are shown as the decision criterion information Is.

### A-2-1-1-2-2-4. Work Condition Display Area 224

In the inspection work display area 214a of FIG. 3, the work content display area 222 displays the work condition, the work key point, and the decision criterion together as described above. In contrast, in the inspection work display area 214b, 214c of FIGS. 3 and 4, the work condition display area 224 displays the work condition, and the work key point/decision criterion display area 226 displays the work key point and the decision criterion. The inspection work display area 214d of FIG. 4 does not have the work condition display area 224 (work conditions are not displayed because they are not necessary).

In the work condition display area 224 of FIG. 3, “IG switch OFF” and “Wiper switch OFF” are the work conditions for measurement when performing the inspection work of the measurement work content display area 230b. In the display area 224 of FIG. 4, “No blown fuse in circuit”, “If any blown fuse, check the circuit”, and “Remove the front wiper motor if necessary” are the work conditions for measurement when performing the inspection work of the measurement work content display area 230c.

### A-2-1-1-2-2-5. Work Key Point/Decision Criterion Display Area 226

Like the work content display area 222, the work key point/decision criterion display area 226 includes a checking work name display area 250, a work key point display area 254, and a decision criterion display area 256.

In the checking work name display area 250 of FIG. 3, “Inspect S1 line for breaks” and “Inspect S1 line for short circuit” each represent a checking work name, and these two works constitute the smallest work item “Circuit inspection on S1 line” displayed in the work item display area 220. In the checking work name display area 250 of FIG. 4, “Inspect motor (LO) driving”, “Inspect motor (HI) driving”, and “Inspect the motor internal circuit” each represent a checking work name, and these three works constitute the smallest work item “Unit inspection of the front wiper motor” displayed in the work item display area 220.

The work key point display area 254 of FIGS. 3 and 4 includes pin names 260a, 260b, pin layouts 262a, 262b, and measurement diagrams 264d to 264h as the work key point information Ip.

### A-2-1-1-2-2-6. Repair Work Display Area 228

The repair work display area 228 is an area which displays repair work information Irp as information on a repair work when an anomaly is found as a result of inspection work. For example, in the inspection work display areas 214a, 214b of FIG. 3, “Repair abnormal wiring” is the repair work information Irp.

### A-2-1-2. Second Fault Instance

Next, as a second fault instance, a case where DTC “P2222” (Circuit anomaly in the front headlight leveling sensor) is detected will be described. Components similar to those in the first fault instance (FIGS. 2 to 4) are denoted with similar reference characters and detailed description on them is omitted.

### A-2-1-2-1. Inspection Work Selection Screen 100

FIG. 5 shows a second example of the inspection work selection screen 100 in this embodiment. The selection screen 100 of FIG. 5 is a screen for selecting an inspection work when a circuit anomaly occurs in a leveling sensor of a front headlight not illustrated. Hereinbelow, the selection screen 100 of FIG. 5 will also be specifically referred to as inspection work selection screen 100b or selection screen 100b.

In the DTC display area 112 of FIG. 5, “P2222” is the DTC and “Circuit anomaly in the front headlight leveling sensor” is the DTC name. In the fault overview display area 114 of FIG. 5, “The headlight auto-leveling control unit detected circuit anomaly in the front headlight leveling sensor” is the overview of the fault.

The circuit diagram 130 (also referred to as “circuit diagram 130b” hereinbelow) in the detection range display area 116 of FIG. 5 shows circuit components of the front headlight (such as the front headlight leveling sensor, the headlight auto-leveling control unit) as the range in which the anomaly indicated by DTC “P2222” can occur, with the broken line 132 in the circuit diagram 130b indicating the detection range. The power line/signal line/GND line side of the headlight auto-leveling control unit is a portion corresponding to DTC “P2222”. In contrast, the inside of the control unit is not enclosed by the broken line 132 and so is not a portion corresponding to DTC “P2222”, but is displayed as a reference component for easy grasping of the detection range.

With regard to the inspection part display area 118 (the inspection work display area), the list description area 150 (FIG. 2) is not present in FIG. 5. With regard to the work item list 152 and the inspection item area 154, the wire harness and the headlight leveling sensor represent the specific inspection items in FIG. 5.

With regard to the work item area 156, in FIG. 5, “Circuit inspection on power line”, “Circuit inspection on signal line”, “Circuit inspection on GND line”, and “Inspection of the front headlight leveling sensor” represent the specific work items. These work items then function as inspection work options 158e to 158h.

With regard to the fault reproduction scheme display area 120, in FIG. 5, the description “Turn POWER switch from ‘OFF mode’ to ‘ON mode’” is the fault reproduction scheme.

### A-2-1-2-2. Inspection Work Description Screen 200

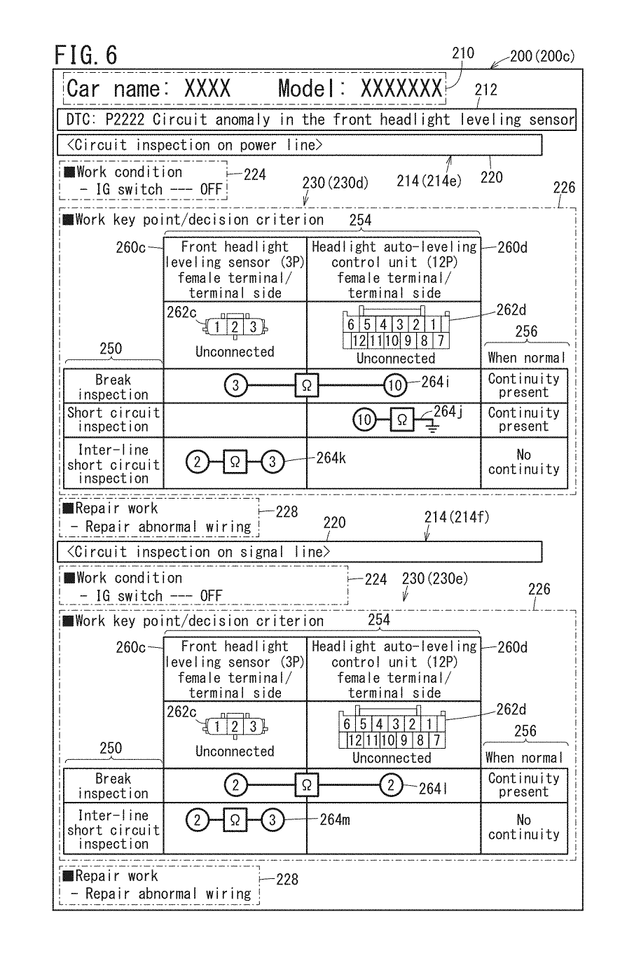

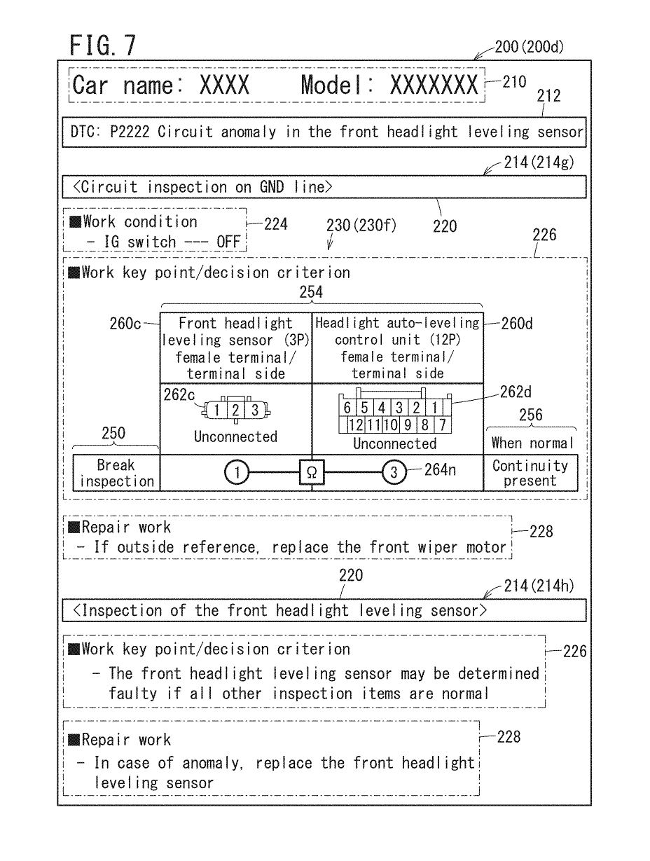

FIGS. 6 and 7 show third and fourth examples of the inspection work description screen 200 for the second fault instance. Hereinafter, the description screen 200 of FIGS. 6 and 7 will also be referred to as inspection work description screen 200c, 200d or description screen 200c, 200d, respectively.

The description screens 200c, 200d of FIGS. 6 and 7 are combined with the inspection work selection screen 100b of FIG. 5. That is, the description screen 200c of FIG. 6 is a screen that appears first upon selection of the option 158e or 158f on the selection screen 100b of FIG. 5. The description screen 200d of FIG. 7 is a screen that appears first upon selection of the option 158g or 158h on the selection screen 100b of FIG. 5.

The four display areas 214 of FIGS. 6 and 7 are also referred to as inspection work display areas 214e to 214h or display areas 214e to 214h. The inspection work display areas 214e to 214h are areas which display the contents of the inspection works (target inspection works) corresponding to the options 158e to 158h of the inspection work selection screen 100.

In the inspection work display areas 214e to 214g of FIGS. 6 and 7, the work condition display area 224 displays the work condition, and the work key point/decision criterion display area 226 displays the work key point and decision criterion. The inspection work display area 214h of FIG. 7 does not have the work condition display area 224.

In the display area 224 of FIGS. 6 and 7, “IG switch—OFF” is the work condition.

The work content display area 230 of FIGS. 6 and 7 is referred to as work content display areas 230d to 230f or display areas 230d to 230f. In the display areas 230d to 230f, pin names 260c, 260d, pin layouts 262c, 262d, and measurement diagrams 264i to 264n are shown.

### A-2-2. Preliminary Setup

Next, preliminary setup for utilizing the electronic manual 90 (FIG. 9) including the inspection work selection screen 100 and the inspection work description screen 200 described above is described. As preliminary setup for the operator 84 to utilize the electronic manual 90, the manual data Dm in the manual DB 50 of the terminal 12 is preferably updated to the latest data periodically or each time it is used. For updating the manual file Fm, the terminal 12 connects to the server 14 and checks whether there is any updated or newly added manual file Fm. If there is an updated or newly added manual file Fm, that manual file Fm is downloaded from the server 14 to the terminal 12.

In a case where the manual DB 50 is not stored in the storage unit 38 of the terminal 12 and the manual file Fm is retrieved from the server 14 when the electronic manual 90 is utilized, the above preliminary setup is not necessary.

Prior to utilizing the electronic manual 90, the operator 84 uses the terminal 12 as a fault diagnostic instrument or uses a separate fault diagnostic instrument to read the trouble code (DTC) stored in the ECU 86 of the vehicle 80 on which diagnosis is to be performed.

### A-2-3. Overall Flow of Actual Utilization

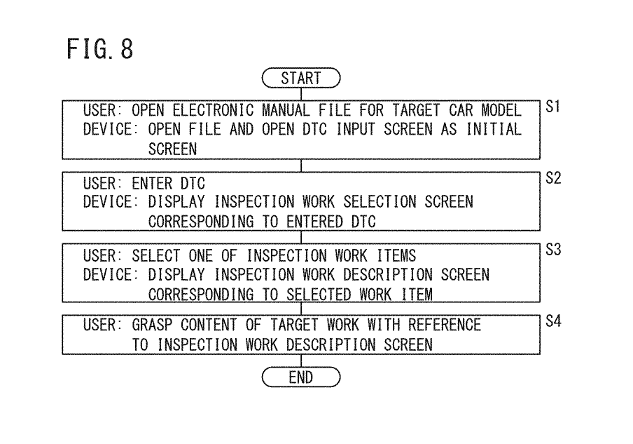

FIG. 8 is a flowchart illustrating an overall flow of the actual utilization of the electronic manual 90 in this embodiment. FIG. 9 illustrates link display among screens in the electronic manual 90 of this embodiment.

At step S1 of FIG. 8, the operator 84 as the user manipulates the operation input unit 34 of the terminal 12 to open the electronic manual file Fm for a vehicle type corresponding to the vehicle 80 (the target vehicle type).

As an initial screen that immediately follows the opening of the electronic manual file Fm, the computation unit 36 displays a DTC input screen (not shown) on the monitor 40. The DTC input screen includes a DTC entry area for entering a DTC and a confirmation button for confirming the entered DTC.

At step S2, the operator 84 enters the DTC read from the ECU 86 of the vehicle 80 in the DTC entry area and presses the confirmation button. In response to it, the computation unit 36 displays the inspection work selection screen 100 (FIGS. 2 and 5) corresponding to the entered DTC on the monitor 40.

The inspection work selection screen 100 (also referred to as “selection screen 100” hereinbelow) is a screen (inspection work selection screen) including the options 158a to 158d (FIGS. 2), 158e to 158h (FIG. 5), which are displayed as independent inspection work items.

At step S3, for selecting from the options 158 displayed on the inspection work selection screen 100, the operator 84 compares and considers the overview of the fault displayed in the fault overview display area 114, the range of electrical wiring between the relevant components that require inspection when the trouble code displayed in the detection range display area 116 is detected, and the smallest work items categorized for the respective inspection items (components) displayed in the inspection part display area 118. The operator 84 further comprehensively considers, for example, the condition of the vehicle 80 and/or information on situations at the time of the fault obtained from the user of the vehicle 80, and selects an option interesting to the operator 84. In response to it, the computation unit 36 displays the inspection work description screen 200 (FIGS. 3, 4, 6, and 7) corresponding to the selected option 158. The inspection work description screen 200 (also referred to as “description screen 200” hereinbelow) is a screen providing detailed description of the inspection work corresponding to the selected option 158 (also referred to as “target inspection work” or “target work” hereinbelow).

At step S4, the operator 84 understands the content of the target work with reference to the inspection work description screen 200 being displayed and actually performs the target work. If the inspection shows a normal result, the operator 84 selects a return button (not shown) on the inspection work description screen 200 to go back to the inspection work selection screen 100, where he/she considers which work item to perform next from a perspective similar to the foregoing, selects a work item, and performs an inspection work.

### A-3. Effects of the Embodiment

As described above, according to this embodiment, the inspection work selection screen 100 displays an overview of a fault corresponding to a DTC (trouble code), a circuit diagram 130 showing the detection range in which the DTC is detected, and multiple options 158 in which the inspection work items corresponding to the DTC and present in the detection range are categorized into smallest work items (FIGS. 2 and 5). Thus, information items for allowing the user to promptly understand the overview of inspection works corresponding to a DTC can be displayed all together on a single screen 100.

There are as many DTCs as more than several hundreds, so that even a professional cannot make a determination only with a DTC and/or its name. This embodiment allows the operator 84 (user) to quickly recognize, just by glancing at a screen, a target component and/or the overview of the work for it, which are commonly difficult to recognize only with a DTC. The operator 84 accordingly can roughly grasp the work processes required for fault diagnosis corresponding to a DTC, the number of processes, and their difficulty levels, and promptly present a repair time or a quote to a customer.

In addition, options 158 for multiple inspection works associated with a DTC and categorized with respect to components in the circuit diagram 130 of the detection range are displayed in units of the smallest inspection works such that they are selectable by the operator 84 (FIGS. 2 and 5).

The operator 84 thus can recognize the inspection works for the fault-causing part in units of the smallest inspection works beforehand. Accordingly, the operator 84 can decide an inspection work procedure on his/her own making use of his/her skills or expertise without having to adhere to a common and standard inspection work order, so that he/she can perform flexible diagnostic work in view of customer information and the like. This can significantly improve the work efficiency of fault diagnosis.

This embodiment uses the circuit diagram 130 which shows the electrical connection relation between the target components in the detection range (FIGS. 2 and 5). Work items are displayed being classified per target component (FIGS. 2 and 5). This enables the operator 84 (user) to easily grasp the overall configuration of a circuit in which a fault corresponding to a DTC has occurred and the individual components therein on the inspection work selection screen 100. Thus, the operator 84 can select inspection works in units of the smallest inspection work at the target component level corresponding to a DTC on the inspection work selection screen 100 and estimate the location of fault occurrence in the circuit more easily. For an operator 84 with high skills in particular, narrowing down of the location of fault occurrence would be facilitated.

The inspection work description screen 200 in this embodiment includes the work content display area 230 which displays a work key point for a measurement work relating to a selected work item and a decision criterion for measured data all together, and the repair work display area 228 which displays the content of a repair work that is to be done when the decision criterion is not satisfied (FIGS. 3, 4, 6, and 7).

In this manner, the work key point (the type of measurement sensor and point of measurement) for a measurement work relating to the selected work item and a decision criterion for measured data are displayed together such as in a juxtaposed manner. Thus, the operator 84 (user) can both grasp the work content of the selected work item at a glance and readily recognize the content of a repair work when the decision criterion is not satisfied.

### B. Variations

As will be apparent, the present invention is not limited to the above embodiment but may adopt other various configurations based on the description provided herein.

For example, it may adopt the following configurations.

### B-1. Target of Application

The above embodiment applies the electronic manual display system 10 or electronic manual display method to the vehicle 80 (FIG. 1). However, the present invention is not limited thereto from the viewpoint of using the inspection work selection screen 100 and the inspection work description screen 200 (FIGS. 2 to 9), for example. For instance, the present invention may be used with apparatuses other than the vehicle 80 (for example, mobile objects such as ships and aircraft, robots, manufacturing devices, or home appliances).

### B-2. Configuration of Electronic Manual Display System 10

In the above embodiment, the terminal 12 was described as being a dealer terminal belonging to dealer A, B (FIG. 1). However, the present invention is not limited thereto from the viewpoint of using the inspection work selection screen 100 and the inspection work description screen 200 (FIGS. 2 to 9), for example. For instance, the terminal 12 may be a personal terminal connected to the Internet.

In the above embodiment, the manual file Fm used on the terminal 12 is a file downloaded from the server 14 and stored in the storage unit 38 of the terminal 12 (FIG. 1). However, the present invention is not limited thereto from the viewpoint of using the inspection work selection screen 100 and the inspection work description screen 200 (FIGS. 2 to 9), for example. For instance, the manual file Fm may be stored in the storage unit 38 via a storage medium (for example, a USB memory). Alternatively, the manual file Fm on the server 14 may be utilized in a so-called application service provider (ASP) fashion, which does not involve downloading.

### B-3. Electronic Manual 90

### B-3-1. Electronic Manual 90 in General

In the electronic manual 90 of the above embodiment, two inspection work description screens 200 are associated with one inspection work selection screen 100 (FIGS. 2 to 9). However, the present invention is not limited thereto when considering the use of the inspection work selection screen 100 and the inspection work description screen 200, for example. For instance, one or three or more inspection work description screens 200 may be associated with one inspection work selection screen 100.

### B-3-2. Inspection Work Selection Screen 100

On the inspection work selection screen 100 of the above embodiment, the options 158 are displayed as links (FIGS. 2 and 5). However, the present invention is not limited thereto from the viewpoint of associating the inspection work selection screen 100 and the inspection work description screen 200 with each other, for example. For instance, it is also possible to associate the inspection work selection screen 100 and the inspection work description screen 200 with each other by pressing an execution button with a check in a checkbox next to the display of each option 158. Alternatively, the options 158 may be selected by voice input via a microphone not illustrated.

The inspection work selection screen 100 of the above embodiment includes the circuit diagram 130 showing the electrical connection relation among multiple parts in which a fault corresponding to a DTC can occur (FIGS. 2 and 5). However, the present invention is not limited thereto from the viewpoint of displaying a connection relation diagram, which shows the physical connection relation among multiple parts in which a fault can occur, together with an overview of a fault corresponding to a DTC (the display area 114) and the options 158, for example.

For instance, a connection relation diagram other than the circuit diagram 130 may be displayed in the detection range display area 116 (connection relation diagram display area). Such a connection relation diagram may be an assembly diagram of various components, for example.

### B-3-3. Inspection Work Description Screen 200

In the above embodiment, the inspection work selection screen 100 is switched to the inspection work description screen 200 upon selection of any one of the options 158 in the inspection work selection screen 100 (FIG. 9). However, the present invention is not limited thereto from the viewpoint of providing specific description of an inspection work upon selection from the options 158, for example. For instance, the inspection work description screen 200 may be displayed over the inspection work selection screen 100. Alternatively, the displayed contents of the inspection work selection screen 100 and the displayed contents of the inspection work description screen 200 may be displayed on the monitor 40 in a juxtaposed manner (or concurrently).

### C. Reference Signs List

36 computation unit (electronic manual control device)
40 monitor (display device)
80 vehicle
84 operator (user)
86 ECU
90 electronic manual
100, 100a, 100b inspection work selection screen
114 fault overview display area
116 detection range display area (connection relation diagram display area)
118 inspection part display area (inspection work display area)
130, 130a, 130b circuit diagram (connection relation diagram)
158a to 158h options
200, 200a to 200d inspection work description screen
228 repair work display area
230 measurement work content display area

What is claim is:

1.-4. (canceled)

5. An electronic manual display method for displaying an electronic manual for performing fault diagnosis based on a trouble code stored in an electronic control unit within a vehicle, wherein
an electronic manual control device configured to control display of the electronic manual includes,
an inspection work selection screen which displays together,
a fault overview display area which displays an overview of a fault corresponding to the trouble code,
a detection range display area which graphically displays a detection range in which the trouble code is detected, and
an inspection part display area which displays inspection work items in the detection range associated with the trouble code by categorizing the inspection work items which are selectable as options, and
an inspection work description screen which displays a detailed description of inspection work content corresponding to each of the work items,
when one of the options is selected on the inspection work selection screen, the inspection work description screen corresponding to the option is displayed on a display device, and
the detection range display area is a circuit diagram showing electrical connection relation between target components in the detection range, and the inspection part display area displays the work items as classified for each of the target components.

6. The electronic manual display method according to claim 5, wherein the inspection work description screen includes
a work content display area which displays a work key point for a measurement work relating to the selected work item and a decision criterion for measured data together in a juxtaposed manner, and
a repair work display area which displays content of a repair work to be done when the decision criterion is not satisfied.

7. An electronic manual control device configured to control display of an electronic manual for performing fault diagnosis based on a trouble code stored in an electronic control unit within a vehicle, the electronic manual control device comprising:
an inspection work selection screen which displays together,
a fault overview display area which displays an overview of a fault corresponding to the trouble code,
a detection range display area which graphically displays a detection range in which the trouble code is detected, and
an inspection part display area which displays inspection work items in the detection range associated with the trouble code by categorizing the inspection work items which are selectable as options; and
an inspection work description screen which displays a detailed description of inspection work content corresponding to each of the work items, wherein
when one of the options is selected on the inspection work selection screen, the inspection work description screen corresponding to the option is displayed on a display device, and
the detection range display area is a circuit diagram showing electrical connection relation between target components in the detection range, and the inspection part display area displays the work items as classified for each of the target components.
